(19) United States
(12) Patent Application Publication
(10) Pub. No.: US 2017/0298480 A1
(43) Pub. Date: Oct. 19, 2017

(54) HIGH THERMAL CONDUCTIVITY ALUMINUM ALLOY

(71) Applicant: Hyundai Motor Company, Seoul (KR)

(72) Inventor: Chang Soo Kim, Gunpo (KR)

(21) Appl. No.: 15/336,606

(22) Filed: Oct. 27, 2016

(30) Foreign Application Priority Data
Apr. 14, 2016 (KR) 10-2016-0045819

(51) Int. Cl. C22C 21/02; F02F 1/24

(52) U.S. Cl. CPC C22C 21/02; F02F 1/24

(57) ABSTRACT

Disclosed is a aluminum alloy compostion including: copper (Cu) in an amount of 1.5 to 2.5 wt %; silicon (Si) in an amount of 3.5 to 4.5 wt %; zirconium (Zr) in an amount of 0.2 to 0.4 wt %; magnesium (Mg) in an amount of 0.1 to 0.4 wt %; zinc (Zn) in an amount of 0.3 wt % or less but greater than 0 wt %; iron (Fe) in an amount of 0.25 wt % but greater than 0 wt %; manganese (Mn) in an amount of 0.03 wt % or less but greater than 0 wt %; nickel (Ni) in an amount of 0.3 wt % or less but greater than 0 wt %; titanium (Ti) in an amount of 0.03 wt % or less but greater than 0 wt %; aluminum (Al) consituting the remiaining balance of the aluminum alloy composition, based on the total weight of the aluminum alloy composition.

### CROSS REFERENCE TO RELATED APPLICATION

The present application claims priority to Korean Patent Application No. 10-2016-0045819, filed Apr. 14, 2016, the entire contents of which is incorporated herein for all purposes by this reference.

### TECHNICAL FIELD

The present invention relates to a high thermal conductivity aluminum alloy that may include zirconium (Zr) as minimizing contents of copper (Cu) and silicon (Si) which may increase strength but reduce thermal conductivity.

### BACKGROUND OF THE INVENTION

A cylinder head is a main component constituting an engine, and is a cooling system component that acts as an inlet of fuel/air and an outlet of combustion gas. In particular, the cylinder head prevents abnormal combustion such as knocking caused when a temperature of a combustion chamber is increased to be a high temperature, and prevents reduction in durability due to high temperature exposure of surrounding metal components, thereby having a significant effect on performance and durability of the engine.

When a material having high thermal conductivity is applied to the cylinder head so that heat of the combustion chamber is favorably transferred to the outside, fuel efficiency can be substantially improved.

In general, as an aluminum alloy has a pure form in which alloy elements are not contained, thermal conductivity becomes increased, but strength becomes deteriorated. Accordingly, it is difficult to apply the material having high thermal conductivity to a vehicle due to a concern of the strength problem.

The cylinder head for a vehicle may require rigidity for having durability to withstand combustion pressure while having an effect for improving fuel efficiency and performance by increasing thermal conductivity, and therefore, development of an aluminum alloy in which deterioration of strength can be prevented has been demanded.

The contents described as the related art have been provided only for assisting in the understanding for the background of the present invention and should not be considered as corresponding to the related art known to those skilled in the art.

### SUMMARY OF THE INVENTION

In preferred aspects, the present invention provides a high thermal conductivity aluminum alloy or an aluminum alloy composition, which may include zirconium (Zr) as minimizing contents of copper (Cu) and silicon (Si) that increase strength but reduce thermal conductivity. Accordingly, deterioration of strength may be prevented.

According to an exemplary embodiment of the present invention, provided is a high thermal conductivity aluminum alloy composition or the aluminum composition that may comprise: copper (Cu) in an amount of 1.5 to 2.5 wt %; silicon (Si) in an amount of 3.5 to 4.5 wt %; zirconium (Zr) in an amount of 0.2 to 0.4 wt %; magnesium (Mg) in an amount of 0.1 to 0.4 wt %; zinc (Zn) in an amount of 0.3 wt % or less but greater than 0 wt %; iron (Fe) in an amount of 0.25 wt % but greater than 0 wt %; manganese (Mn) in an amount of 0.03 wt % or less but greater than 0 wt %; nickel (Ni) in an amount of 0.3 wt % or less but greater than 0 wt %; titanium (Ti) in an amount of 0.03 wt % or less but greater than 0 wt %; aluminum (Al) consituting the remiaining balance of the aluminum alloy composition, based on the total weight of the aluminum alloy composition.

Unless otherwise indicated, the “wt %” as used herein refers to a content of component in the aluminum alloy as measured in % by weight based on the total weight of the aluminum alloy composition.

In one preferred aspect, the aluminum alloy composition may contain an aluminum (Al)-silicon (Si)-zirconium (Zr)-based crystalline phase such as AlₓSi_{y}Zr_{z}.

Preferably, castability of the aluminum alloy composition may be about 31 cm or greater. The castability may be substantially influenced by a fluidity of an alloy, and can be obtained by measuring a length of flow of the alloys during a predetermined time.

For example, when the length thereof is longer, the castability may be greater.

Preferably, a tensile strength of the aluminum alloy composition may be about 250 MPa or greater.

Preferably, a thermal conductivity of the aluminum alloy composition may be about 175 W/m·K or greater.

Moreover, the present invention provides the aluminum alloy composition that may consist essentially of, essentially consist of or consist of the components as described herein. For example, the aluminum alloy composition may consist essentially of, essentially consist of or consist of: copper (Cu) in an amount of 1.5 to 2.5 wt %; silicon (Si) in an amount of 3.5 to 4.5 wt %; zirconium (Zr) in an amount of 0.2 to 0.4 wt %; magnesium (Mg) in an amount of 0.1 to 0.4 wt %; zinc (Zn) in an amount of 0.3 wt % or less but greater than 0 wt %; iron (Fe) in an amount of 0.25 wt % but greater than 0 wt %; manganese (Mn) in an amount of 0.03 wt % or less but greater than 0 wt %; nickel (Ni) in an amount of 0.3 wt % or less but greater than 0 wt %; titanium (Ti) in an amount of 0.03 wt % or less but greater than 0 wt %; aluminum (Al) consituting the remiaining balance of the aluminum alloy composition, based on the total weight of the aluminum alloy composition.

Further provided is a vehicle part that may comprise the aluminum alloy composition as described herein. The vehicle part may include a cylinder head of a vehicle.

Other aspects of the invention are disclosed infra.

### BRIEF DESCRIPTION OF THE DRAWINGS

FIG. 1 is a graph illustrating changes in thermal conductivity at various contents of copper (Cu) and silicon (Si).

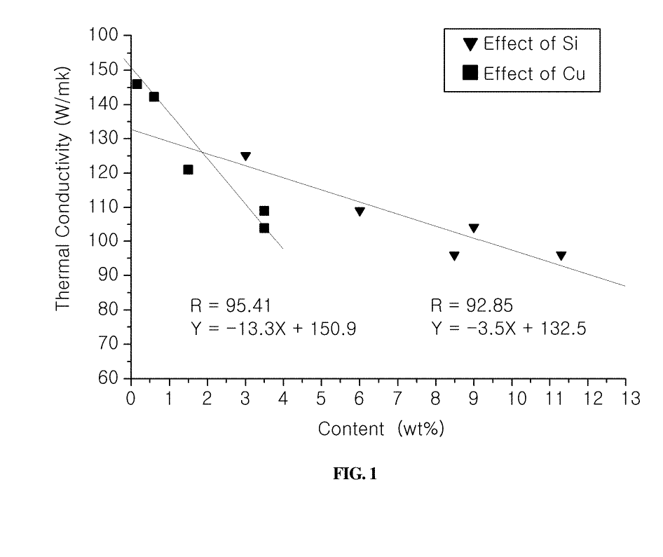

FIG. 2 is an image illustrating an exemplary structure formed in an exemplary aluminum alloy according to an exemplary embodiment of the present invention.

FIG. 3 is a graph illustrating changes in tensile strength at various contents of copper (Cu).

FIG. 4 is a graph illustrating changes in thermal conductivity at various contents of copper (Cu).

FIG. 5 is a graph illustrating changes in castability at various contents of silicon (Si).

FIG. 6 is a graph illustrating changes in tensile strength at various contents of silicon (Si).

FIG. 7 is a graph illustrating changes in thermal conductivity at various contents of silicon (Si).

FIG. 8 is a graph illustrating changes in tensile strength at contents of zirconium (Zr).

FIG. 9 is a graph illustrating changes in thermal conductivity at various contents of zirconium (Zr).

### DETAILED DESCRIPTION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, exemplary embodiments of the present invention will be described with reference to the accompanying drawings.

In one aspect, the present inventin provides a high thermal conductivity aluminum alloy or an aluminum alloy composition having a high thermal conductivity. The aluminum alloy composition may comprise: copper (Cu) in an amount of 1.5 to 2.5 wt %; silicon (Si) in an amount of 3.5 to 4.5 wt %; zirconium (Zr) in an amount of 0.2 to 0.4 wt %; magnesium (Mg) in an amount of 0.1 to 0.4 wt %; zinc (Zn) in an amount of 0.3 wt % or less but greater than 0 wt %; iron (Fe) in an amount of 0.25 wt % but greater than 0 wt %; manganese (Mn) in an amount of 0.03 wt % or less but greater than 0 wt %; nickel (Ni) in an amount of 0.3 wt % or less but greater than 0 wt %; titanium (Ti) in an amount of 0.03 wt % or less but greater than 0 wt %; aluminum (Al) consituting the remiaining balance of the aluminum alloy composition, based on the total weight of the aluminum alloy composition.

Hereinafter, in the high thermal conductivity aluminum alloy according to the present invention, a reason in which the components of the alloy are limited is described in detail.

(1) Copper (Cu) in an Amount of About 1.5 to 2.5 wt %

Copper (Cu) as used herein may improve tensile strength by forming Al₂Cu crystallization phase. When a content of copper is less than about 1.5 wt %, tensile strength may not be improved sufficiently. On the contrary, when the content of copper is greater than about 2.5 wt %, thermal conductivity may be reduced by precipitation of intermetallic compounds, and therefore, the content of copper (Cu) suitably may be within a range of 1.5 to 2.5 wt % based on the total weight of the aluminum alloy composition.

(2) Silicon (Si) in an Amount of About 3.5 to 4.5 wt %

Silicon (Si) as used herein may improve castability and strength. When a content of silicon is less than about 3.5 wt %, castability and strength may not be improved sufficiently. On the contrary, when the content of silicon is greater than about 4.5 wt %, thermal transfer may be inhibited and thermal conductivity may be reduced. Therefore, the content of silicon (Si) suitably may be within a range of about 3.5 to 4.5 wt % based on the total weight of the aluminum alloy composition.

(3) Zirconium (Zr) in an Amount of About 0.2 to 0.4 wt %

Zirconium as used herein may increase mechanical properties such as strength since Zr may induce crystallization of an aluminum (Al)-silicon (Si)-zirconium (Zr)-based crystalline phase such as AlₓSi_{y}Zr_{z} in the alloy structure. When a content of zirconium is less than about 0.2 wt %, strength may not be improved sufficiently, and when the content of zirconium is greater than about 0.4 wt %, strength may be increased, but thermal conductivity may be rapidly reduced, and accordingly, the content of zirconium (Zr) suitably may be within a range of about 0.2 to 0.4 wt % based on the total weight of the aluminum alloy composition.

(4) Magnesium (Mg) in an Amount of About 0.1 to 0.4 wt %

Magnesium (Mg) as used herein may improve strength by forming a Mg₂Si compound with silicon (Si). When a content of magnesium is less than about 0.1 wt %, strength may not be improved sufficiently, but when the content of magnesium is greater than about 0.4 wt %, an oxidation tendency of a molten metal may increase at the time of casting. Therefore, the content of magnesium (Mg) suitably may be within a range of about 0.1 to 0.4 wt % based on the total weight of the aluminum alloy composition.

(5) Zinc (Zn) in an Amount of About 0.3 wt % or Less

When a content of zinc (Zn) is greater than about 0.3 wt %, thermal conductivity may be rapidly reduced. Therefore, the content of the zinc (Zn) suitably may be in an amount 0.3 wt % or less based on the total weight of the aluminum alloy composition.

(6) Iron (Fe) in an Amount of About 0.25 wt % or Less

Iron (Fe) as used herein may promote solid solution of the alloy composition, when the other components of the alloy may form an intermetallic compound, thereby contributing to enhancement of dispersion thereof. As consequence, by adding iron, strength may be improved. When a content of iron is greater than about 0.25 wt %, castability may be reduced, and thermal conductivity may be reduced. The content of iron (Fe) suitably may be limited to about 0.25 wt % or less based on the total weight of the aluminum alloy composition.

(7) Manganese (Mn) in an Amount of About 0.03 wt % or Less

Manganese (Mn) as used herein may improve strength by promoting solid solution. When a content of manganese is greater than about 0.03 wt %, thermal conductivity may be rapidly reduced. The content of manganese (Mn) suitably may be limited to 0.03 wt % or less based on the total weight of the aluminum alloy composition.

(8) Nickel (Ni) in an Amount of About 0.3 wt % or Less

Nickel (N) as used herein may promote solid solution like as the iron (Fe). In addition, nickel may also form an intermetallic compound together with the iron (Fe), thereby contributing to enhancement of dispersion. As consequence, strength may be improved. When a content of nickel is greater than about 0.3 wt %, is the Ni content may be saturated, such that strength may not improve according to the content, and thermal conductivity may be reduced. The content of the nickel (Ni) suitably may be limited to about 0.3 wt % or less based on the total weight of the aluminum alloy composition.

(9) Titanium (Ti) in an Amount of About 0.03 wt % or Less

Titanium (Ti) as used herein may improve castability and strength. When a content of titanium is greater than about 0.03 wt %, thermal conductivity may be substantially reduced. The content of the titanium (Ti) suitably may be limited to 0.03 wt % or less based on the total weight of the aluminum alloy composition.

### EXAMPLE

Hereinafter, the aluminum alloy composition according to various exemplary embodiments of the present invention will be described with reference to the accompanying drawings.

Alloy components of a conventional aluminum alloy material (AC2BH) are shown in Table 1 below.

TABLE 1

| | Copper | Silicon | Magnesium | Zinc | Iron | Manganese | Nickel | Titanium | Aluminum |
|---|---|---|---|---|---|---|---|---|---|
| | (Cu) | (Si) | (Mg) | (Zn) | (Fe) | (Mn) | (Ni) | (Ti) | (Al) |
| Component | (wt %) | (wt %) | (wt %) | (wt %) | (wt %) | (wt %) | (wt %) | (wt %) | (wt %) |
| Existing | 2.0~4.0 | 5.0~7.0 | 0.1~0.4 | 0.3 or less | 0.25 | 0.03 | 0.3 | 0.03 | Balance |
| material | | | | | or less | or less | or less | or less | |
| (AC2BH) | | | | | | | | | |

Tensile strength and thermal conductivity may be physical properties in a Trade-off relationship. When contents of copper (Cu) and silicon (Si) were reduced as shown in the following Tables 2 and 3, strength was deteriorated, and on the contrary, when the contents thereof were increased, thermal conductivity was reduced. Here, a practically performed heat treatment was a T7 heat treatment (solution heat treatment: performed at a temperature of about 500° C. for about 5 hours, aging: performed at about 250° C. for about 4.5 hours).

TABLE 2

| Tensile Strength | | Copper (Cu) | | |
|---|---|---|---|---|
| (MPa) | | 1.0 wt % | 2.0 wt % | 3.0 wt % |
| Silicon (Si) | 6.0 wt % | 237 | 245 | 262 |
| | 5.0 wt % | 219 | 227 | 256 |
| | 4.0 wt % | 199 | 206 | 216 |
| | 3.0 wt % | 193 | 201 | 209 |

TABLE 3

| Thermal Conductivity | | Copper (Cu) | | |
|---|---|---|---|---|
| (W/m · K) | | 1.0 wt % | 2.0 wt % | 3.0 wt % |
| Silicon | 6.0 wt % | 181 | 173 | 163 |
| (Si) | 5.0 wt % | 185 | 177 | 164 |
| | 4.0 wt % | 195 | 193 | 167 |
| | 3.0 wt % | 199 | 195 | 171 |

As shown in Tables 2 and 3, tensile strength and thermal conductivity changed according to changes in the contents of copper (Cu) and silicon (Si), which may be indicated by the Trade-off relationship between copper (Cu) and silicon (Si).

Accordingly, the present invention may provide a high thermal conductivity aluminum alloy in which thermal conductivity may be improved by reducing the contents of copper (Cu) and silicon (Si) as compared to the conventional alloy, and in which deterioration of tensile strength may be prevented by adding zirconium (Zr) for compensation for deteriorated tensile strength.

Alloy components between the conventional material and Example 1 of the high thermal conductivity aluminum alloy according to the present invention are shown in the following Table 4, and evaluation of physical properties of the existing material, Comparative Example 1, and Example 1 are shown in the following Table 5.

TABLE 4

| | Copper | Silicon | Magnesium | Zinc | Iron | Manganese | Nickel | Titanium | Zirconium | Aluminum |
|---|---|---|---|---|---|---|---|---|---|---|
| Component | (Cu) | (Si) | (Mg) | (Zn) | (Fe) | (Mn) | (Ni) | (Ti) | (Zr) | (Al) |
| Existing | 2.0~4.0 | 5.0~7.0 wt | 0.1~0.4 | 0.3 wt % | 0.25 wt % | 0.03 wt % or | 0.3 wt % | 0.03 wt % | — | Balance |
| material | wt % | % | wt % | or less | or less | less | or less | or less | | |
| (AC2BH) | 2.85 wt | 6.25 wt % | 0.20 wt % | 0.01% | 0.17 wt % | — | — | 0.03 wt % | — | Balance |
| | % | | | | | | | | | |
| Example 1 | 1.5~2.5 | 3.5~4.5 | 0.1~0.4 | 0.3% or | 0.25 wt % | 0.03 wt % or | 0.3 wt % | 0.03 wt % | 0.2~0.4 | Balance |
| | wt % | wt % | wt % | less | or less | less | or less | or less | wt % | |
| | 1.95 wt | 4.20 wt % | 0.22 wt % | 0.01% | 0.16 wt % | 0.03 wt % | 0.3 wt % | 0.03 wt % | 0.32 wt % | Balance |
| | % | | | | | | | | | |

TABLE 5

| | Tensile | Thermal | |
|---|---|---|---|
| Clas- | Strength | Conductivity | |
| sification | (MPa) | (W/m · K) | Note |
| Existing | 262 | 163 | Al—3Cu—6Si—Mg—Fe |
| material | | | |
| (AC2BH) | | | |
| Comparative | 206 | 193 | Al—2Cu—4Si—Mg—Fe |
| Example 1 | | | |
| Example 1 | 261 | 181 | Al—2Cu—4Si—Mg—Fe—0.3Zr |

As shown in Tables 4 and 5, in Comparative Example 1, when the content of copper (Cu) was reduced from 3 wt % to 2 wt % and the content of silicon (Si) was reduced from and 6 wt % to 4 wt % as compared to the conventional alloy, tensile strength at the time of T7 heat treatment was reduced from 262 MPa to 206 MPa, i.e., reduced by about 21%. In addition, thermal conductivity which is in a Trade-off relationship with the tensile strength was increased from 163 W/m·K to 193 W/m·K, i.e., increased by about 22%.

In Example 1, tensile strength was maintained as the same level as the conventional alloy, but a reduction width of thermal conductivity was minimized by adding the content of zirconium (Zr) in the above described range and simultaneously reducing the contents of copper (Cu) and silicon (Si) as compared to the conventional alloy.

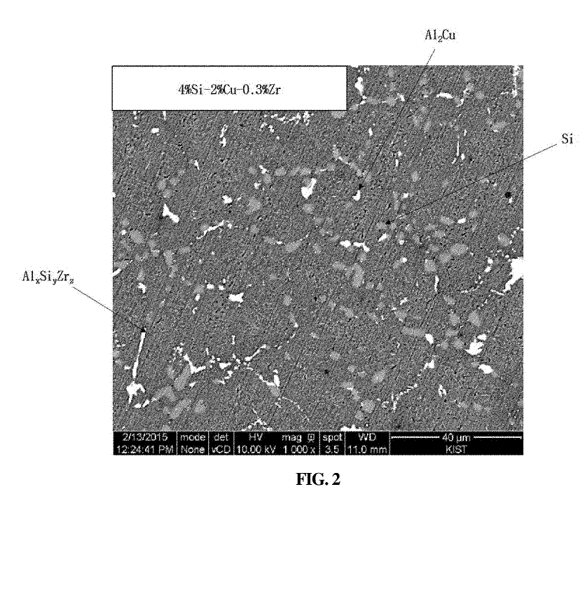

As described above, the zirconium (Zr) was added in the above described range, for example, about 0.2 to 0.4 wt %, such that mechanical properties were increased by crystallization of the Al—Si—Zr-based crystalline phase such as AlₓSi_{y}Zr_{z} even without a large reduction of thermal conductivity. FIG. 2 also shows Al—Si—Zr-based crystalline phase formed in an exemplary aluminum alloy composition according to an exemplary embodiment of the present invention.

In particular, when the content of zirconium (Zr) was less than about 0.2 wt %, an effect of increasing strength was reduced, such that 250 Mpa or greater of tensile strength, which is a development standard of the cylinder head, was not satisfied. When the content of zirconium (Zr) was greater than about 0.4 wt %, the tensile strength satisfied the development standard, and was rather deteriorated than the development standard. Particularly, the thermal conductivity thereof was deteriorated to be less than 175 W/m·K, which is the development standard. Therefore, the content of zirconium (Zr) may be limited to be about 0.2 to 0.4 wt % based on the total weight of the aluminum alloy composition.

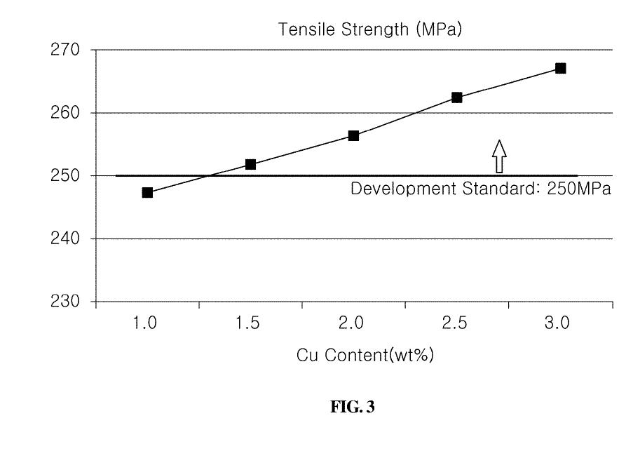

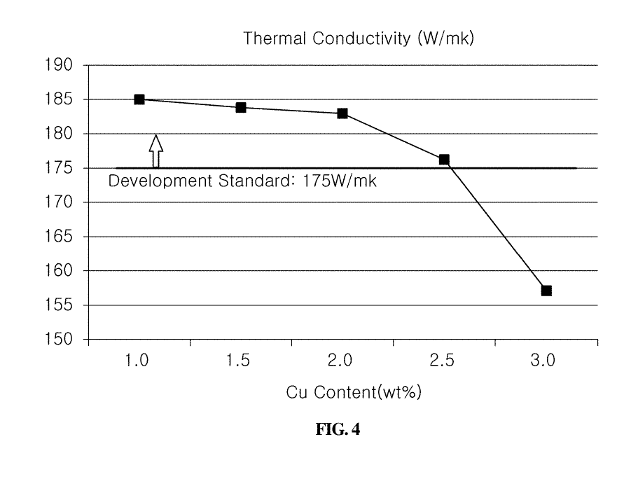

An effect obtained by controlling the content of copper (Cu) are shown in the following Table 6, and FIGS. 3 and 4.

TABLE 6

| | | | Thermal |
|---|---|---|---|
| | Copper (Cu) | Tensile Strength | Conductivity |
| | Content (wt %) | (MPa) | (W/m · K) |
| Comparative | 1.0 | 199 | 195 |
| Example 2 | | | |
| Example 2 | 1.5 | 202 | 194 |
| Example 3 | 2.0 | 206 | 193 |
| Example 4 | 2.5 | 212 | 186 |
| Comparative | 3.0 | 216 | 167 |
| Example 3 | | | |

In Comparative Examples and Examples of Table 6, other elements were controlled to the same level within a limited range of an exemplary aluminum alloy according to an exemplary embodiment of the present invention, and only the copper (Cu) content was varied.

Since the content of copper (Cu) was limited to be within a range of 1.5 to 2.5 wt %, the content of copper (Cu) was less than 1.5 wt % in Comparative Example 2, and the content of copper (Cu) was greater than 2.5 wt % in Comparative Example 3.

As illustrated in FIG. 3, as the content of copper (Cu) was increased, tensile strength was gradually increased, and when the content of copper (Cu) was less than 1.5 wt %, the tensile strength did not meet a development standard. As illustrated in FIG. 4, thermal conductivity was rapidly reduced from between 2.5 wt % and 3.0 wt %.

Accordingly, the content of copper (Cu) suitably may be within a range of about 1.5 to 2.5 wt % based on the total weight of the aluminum alloy composition.

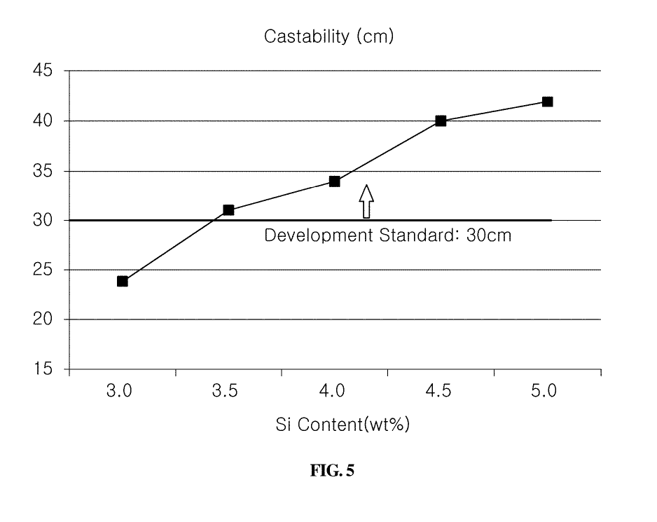

An effect obtained by controlling the content of silicon (Si) could be confirmed through Table 7 below, and FIGS. 5 to 7.

TABLE 7

| | | Tensile | Thermal | Castability |
|---|---|---|---|---|
| | Silicon (Si) | Strength | Conductivity | (fluidity) |
| | Content (wt %) | (MPa) | (W/m · K) | (cm) |
| Comparative | 3.0 | 201 | 195 | 24 |
| Example 4 | | | | |
| Example 5 | 3.5 | 202 | 194 | 31 |
| Example 6 | 4.0 | 206 | 193 | 34 |
| Example 7 | 4.5 | 216 | 195 | 40 |
| Comparative | 5.0 | 227 | 177 | 42 |
| Example 5 | | | | |

In Comparative Examples and Examples of Table 7, other elements were controlled to the same level within the above described range of an exemplary aluminum alloy according to an exemplary embodiment of the present invention, and only the content silicon (Si) was varied.

Since the content of silicon (Si) was limited to be within the range of about 3.5 to 4.5 wt %, the content of silicon (Si) was less than 3.5 wt % in Comparative Example 4, and the content of silicon (Si) was more than 4.5 wt % in Comparative Example 5.

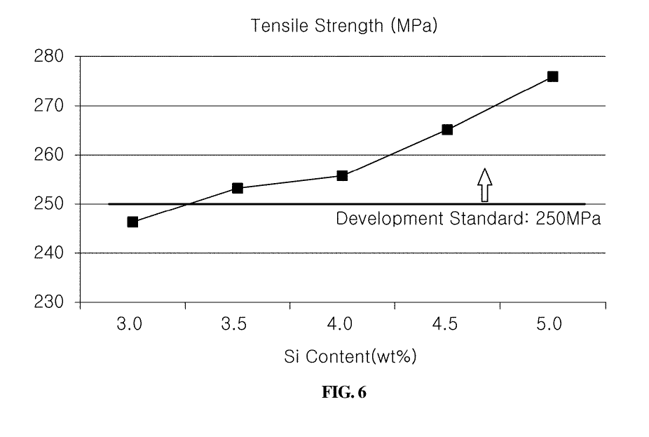

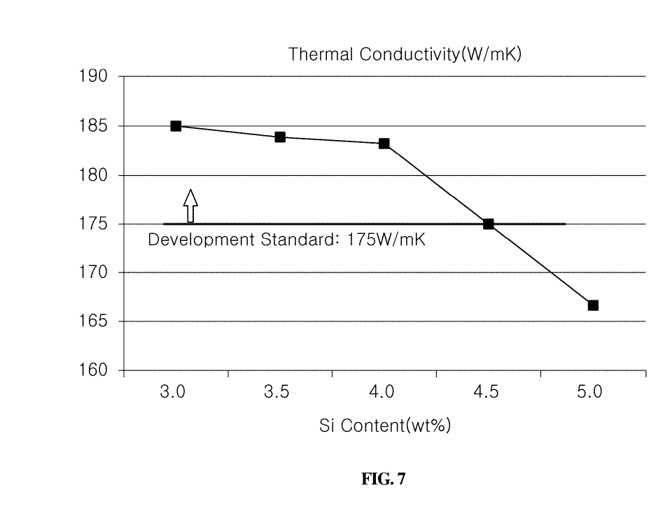

As illustrated in FIG. 6, as the content of silicon (Si) was increased, tensile strength was gradually increased, and when the content of silicon (Si) was less than 3.5 wt %, the tensile strength did not meet a development standard. As illustrated in FIG. 7, thermal conductivity was rapidly reduced from 4.0 wt %, and when the content of silicon (Si) was greater than 4.5 wt %, thermal conductivity did not meet a development standard.

In addition, as illustrated in FIG. 5, as the content of silicon (Si) was increased, castability (fluidity) was gradually increased, and when the content of silicon (Si) was less than 3.5 wt %, the castability (fluidity) was not good enough to cast the alloy into the cylinder head. The castability can be evaluated by relatively comparing flow rate lengths of alloys during a predetermined time. For example, when the length thereof is longer, the castability may be greater. Accordingly, the content of silicon (Si) may be limited to be within a range of about 3.5 to 4.5 wt %, and or particularly of about 3.5 to 4.0 wt % based on the total weight of the aluminum alloy composition.

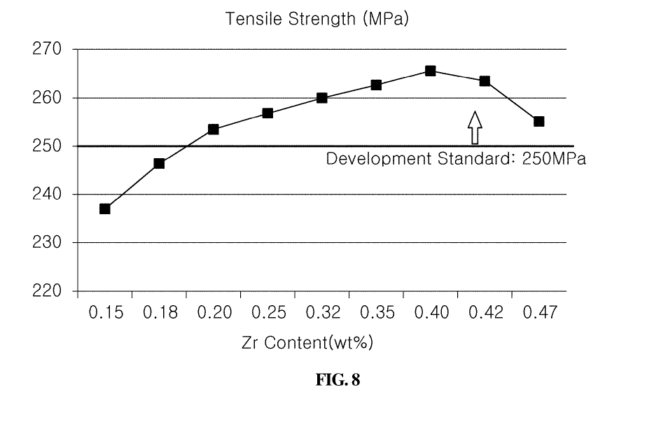

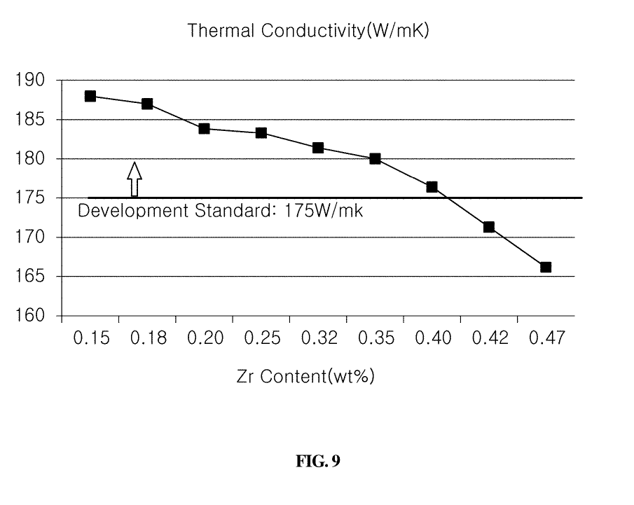

An effect obtained by controlling the content of zirconium (Zr) could be confirmed through Table 8 below, and FIGS. 8 and 9.

TABLE 8

| | | Tensile | Thermal |
|---|---|---|---|
| | Zirconium (Zr) | Strength | Conductivity |
| | Content (wt %) | (MPa) | (W/m · K) |
| Comparative Example 6 | 0.15 | 237 | 188 |
| Comparative Example 7 | 0.18 | 246 | 187 |
| Example 8 | 0.20 | 253 | 184 |
| Example 9 | 0.25 | 257 | 183 |
| Example 10 | 0.32 | 260 | 181 |
| Example 11 | 0.35 | 262 | 180 |
| Example 12 | 0.40 | 265 | 176 |
| Comparative Example 8 | 0.42 | 263 | 171 |
| Comparative Example 9 | 0.47 | 255 | 166 |

In Comparative Examples and Examples of Table 8, other elements were controlled to the same level within the above described content range of an exemplary aluminum alloy according to an exemplary embodiment of the present invention, and only the content of zirconium (Zr) was varied.

Since the content of zirconium (Zr) was limited to be within a range of 0.20 to 0.40 wt %, the content of zirconium (Zr) was less than 0.20 wt % in Comparative Examples 6 and 7, and the content of zirconium (Zr) was more than 0.40 wt % in Comparative Examples 8 and 9.

As illustrated in FIG. 8, as the content of zirconium (Zr) was increased, tensile strength was gradually increased, and when the content of zirconium (Zr) was 0.40 wt % or greater, the tensile strength was rather reduced. On the contrary, as illustrated in FIG. 9, as the content of zirconium (Zr) was increased, thermal conductivity was gradually reduced, and rapidly reduced from 0.40 wt %. Accordingly, the content of zirconium (Zr) may be within a range of about 0.20 to 0.40 wt % based on the total weight of the aluminum alloy composition.

In another aspect, a cylinder head according to the present invention may be formed using an exemplary high thermal conductivity aluminum alloy. The aluminum alloy may comprise: copper (Cu) in an amount of 1.5 to 2.5 wt %; silicon (Si) in an amount of 3.5 to 4.5 wt %; zirconium (Zr) in an amount of 0.2 to 0.4 wt %; magnesium (Mg) in an amount of 0.1 to 0.4 wt %; zinc (Zn) in an amount of 0.3 wt % or less but greater than 0 wt %; iron (Fe) in an amount of 0.25 wt % but greater than 0 wt %; manganese (Mn) in an amount of 0.03 wt % or less but greater than 0 wt %; nickel (Ni) in an amount of 0.3 wt % or less but greater than 0 wt %; titanium (Ti) in an amount of 0.03 wt % or less but greater than 0 wt %; aluminum (Al) consituting the remiaining balance of the aluminum alloy composition, based on the total weight of the aluminum alloy composition.

As consequence, the cylinder head according to the present invention may obtain a tensile strength of about 250 MPa or greater, and a thermal conductivity of about 175 W/m·K or greater.

According to various exemplary aluminum alloys or compositions thereof in the present invention as described above, deterioration of strength may be prevented by adding zirconium (Zr) and minimizing contents of copper (Cu) and silicon (Si) that increase strength but reduce thermal conductivity.

The cylinder head formed of the high thermal conductivity aluminum alloy according to the present invention may have improved thermal conductivity by about 12% (for example, 163→181 W/m·K) while maintaining the same strength as that of the existing cylinder head. In particular, when the cylinder head formed of the high thermal conductivity aluminum alloy according to the present invention is applied to vehicles, an effect that fuel efficiency may be improved by about 0.2%.

Although the present invention has been shown and described with respect to various exemplary embodiments, it will be obvious to those skilled in the art that the present invention may be variously modified and altered without departing from the spirit and scope of the present invention as defined by the following claims.

What is claimed is:

1. An aluminum alloy composition comprising:
copper (Cu) in an amount of 1.5 to 2.5% by weight;
silicon (Si) in an amount of 3.5 to 4.5% by weight;
zirconium (Zr) in an amount of 0.2 to 0.4% by weight;
magnesium (Mg) in an amount of 0.1 to 0.4% by weight;
zinc (Zn) in an amount of 0.3% by weight or less but greater than 0% by weight;
iron (Fe) in an amount of 0.25% by weight or less but greater than 0% by weight;
manganese (Mn) in an amount of 0.03% by weight or less but greater than 0% by weight;
nickel (Ni) in an amount of 0.3% by weight or less but greater than 0% by weight;
titanium (Ti) in an amount of 0.03% by weight or less but greater than 0% by weight;
aluminum (Al) consituting the remiaining balance of the aluminum alloy composition,
all the % by weights based on the total weight of the aluminum alloy composition.

2. The aluminum alloy composition of claim 1, wherein the aluminium alloy composition comprises an aluminum (Al)-silicon (Si)-zirconium (Zr)-based crystalline phase.

3. The aluminum alloy composition of claim 1, wherein a castability of the aluminium alloy composition is about 31 cm or greater.

4. The aluminum alloy composition of claim 1, wherein a tensile strength of the aluminium alloy composition is about 250 MPa or greater.

5. The aluminum alloy composition of claim 1, wherein a thermal conductivity of the aluminium alloy composition is about 175 W/m·K or greater.

6. The aluminum alloy composition of claim 1, consisting essentially of:
copper (Cu) in an amount of 1.5 to 2.5% by weight;
silicon (Si) in an amount of 3.5 to 4.5% by weight;
zirconium (Zr) in an amount of 0.2 to 0.4% by weight;
magnesium (Mg) in an amount of 0.1 to 0.4% by weight;
zinc (Zn) in an amount of 0.3% by weight or less but greater than 0% by weight;
iron (Fe) in an amount of 0.25% by weight or less but greater than 0% by weight;
manganese (Mn) in an amount of 0.03% by weight or less but greater than 0% by weight;
nickel (Ni) in an amount of 0.3% by weight or less but greater than 0% by weight;
titanium (Ti) in an amount of 0.03% by weight or less but greater than 0% by weight;
aluminum (Al) consituting the remiaining balance of the aluminum alloy composition,
all the % by weights based on the total weight of the aluminum alloy composition.

7. The aluminum alloy composition of claim 1, consisting of:
copper (Cu) in an amount of 1.5 to 2.5% by weight;
silicon (Si) in an amount of 3.5 to 4.5% by weight;
zirconium (Zr) in an amount of 0.2 to 0.4% by weight;
magnesium (Mg) in an amount of 0.1 to 0.4% by weight;
zinc (Zn) in an amount of 0.3% by weight or less but greater than 0% by weight;
iron (Fe) in an amount of 0.25% by weight or less but greater than 0% by weight;
manganese (Mn) in an amount of 0.03% by weight or less but greater than 0% by weight;
nickel (Ni) in an amount of 0.3% by weight or less but greater than 0% by weight;
titanium (Ti) in an amount of 0.03% by weight or less but greater than 0% by weight;
aluminum (Al) consituting the remiaining balance of the aluminum alloy composition,
all the % by weights based on the total weight of the aluminum alloy composition.

8. A vehicle part that comprising an aluminum alloy composition of claim 1.

9. The vehicle part of claim 8, wherein the vehicle part is a cylinder head.
